(19) United States
(12) Patent Application Publication
(10) Pub. No.: US 2025/0184950 A1
(43) Pub. Date: Jun. 5, 2025

(54) POWER SAVING POSITIONING FOR WIRELESS COMMUNICATIONS

(71) Applicant: ZTE Corporation, Shenzhen (CN)

(72) Inventors: Yu Pan, Shenzhen (CN); Chuangxin Jiang, Shenzhen (CN); Juan Liu, Shenzhen (CN); Di Zong, Shenzhen (CN); Jing Liu, Shenzhen (CN)

(73) Assignee: ZTE Corporation, Shenzhen (CN)

(21) Appl. No.: 18/972,081

(22) Filed: Dec. 6, 2024

Related U.S. Application Data
(63) Continuation of application No. PCT/CN2022/103090, filed on Jun. 30, 2022.

(51) Int. Cl. H04W 64/00; H04L 5/00; H04W 8/22; H04W 52/02; H04W 68/02; H04W 76/20

(52) U.S. Cl. CPC H04W 64/00; H04L 5/0051; H04W 8/22; H04W 52/0261; H04W 68/02; H04W 76/20

(57) ABSTRACT

This document generally relates to wireless communication that includes: a wireless access node that transits a positioning time window configuration to indicate a positioning time window for an idle state or an inactive state to a user device. In response to receiving the positioning time window configuration, the user device is configured to receive a positioning reference signal (PRS) or transmit a sounding reference signal (SRS) in the positioning time window in the idle state or the inactive state.

### CROSS-REFERENCE TO RELATED APPLICATION

This application is a continuation of International Patent Application No. PCT/CN2022/103090, filed Jun. 30, 2022. The contents of International Patent Application No. PCT/CN2022/103090 are herein incorporated by reference in their entirety.

### TECHNICAL FIELD

This document is directed generally to configuring a positioning time window for low power high accuracy positioning for wireless communication.

### BACKGROUND

In wireless communication systems, a user device may have to wake up from an inactive or idle state in order to receive a positioning reference signal (PRS) or to transmit a sounding reference signal (SRS), which may cause the user device to consume large amounts of ramp up/ramp down power. Ways to reduce power consumption may be desirable.

### SUMMARY

This document relates to methods, systems, apparatuses and devices for wireless communication. In some implementations, a method for wireless communication includes: determining, with a wireless access node, a positioning time window to occur during an idle state or an inactive state of a user device; and transmitting, with the wireless access node, a positioning time window configuration to indicate the positioning time window for the idle state or the inactive state to the user device, wherein the user device is allowed to receive a positioning reference signal (PRS) or to transmit a sounding reference signal (SRS) in the idle state or the inactive state.

In some other implementations, a method for wireless communication includes: receiving, with a user device, a positioning time window configuration to indicate a positioning time window for an idle state or an inactive state from a wireless access node; and in response to receiving the positioning time window configuration, with the user device, at least one of: receiving a positioning reference signal (PRS) or transmitting a sounding reference signal (SRS) in the positioning time window in the idle state or the inactive state.

In some other implementations, a device, such as a network device, is disclosed. The device may include one or more processors and one or more memories, wherein the one or more processors are configured to read computer code from the one or more memories to implement any of the methods above.

In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a block diagram of an example configuration of a wireless access node of the wireless communication system of FIG. 1.

FIG. 3 shows an example method for wireless communication that relates to positioning in an idle or inactive state of a user device.

FIG. 4 shows another example method for wireless communication that relates to positioning in an idle or inactive state of a user device.

FIG. 5 shows a timing diagram of an example of a positioning time window.

### DETAILED DESCRIPTION

The present description describes various embodiments of systems, apparatuses, devices, and methods for wireless communications involving configuring a positioning time window for low power high accuracy positioning for wireless communication.

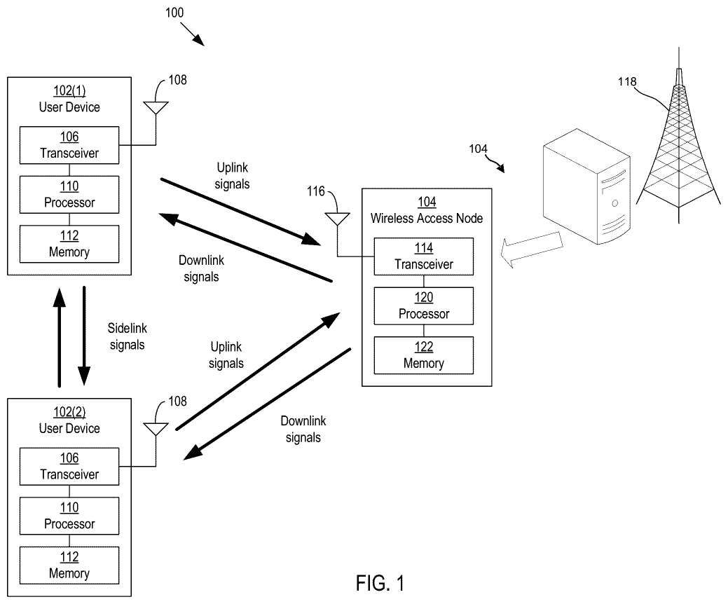

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access node 104. However, various other examples of the wireless communication system 100 that include any of various combinations of one or more user devices 102 and/or one or more wireless access nodes 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise at least one of: a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, or a location management function (LMF), in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

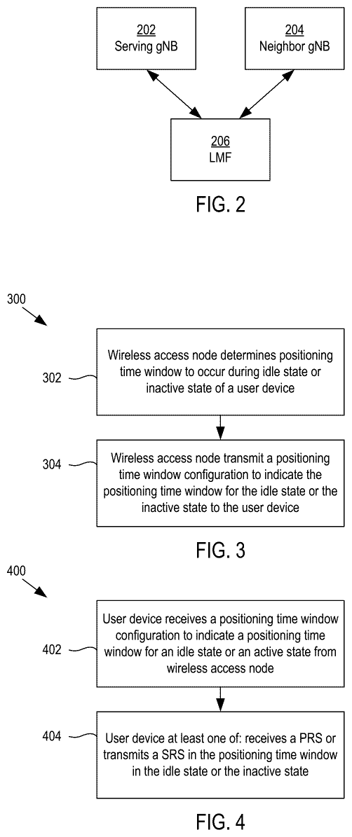

FIG. 2 shows a block diagram of an example configuration of a wireless access node 104. In the example configuration, the wireless access node 104 include a serving gNB 202, a neighbor gNB 204, and a location management function (LMF) 206. Each of the serving gNB 202, the neighbor gNB, and the LMF may be configured in hardware or a combination of hardware and software, such as by having a processor 120, a memory 122, transceiver circuitry 114, an antenna 116, and/or an antenna tower 118, such as shown in FIG. 1 for the wireless access node 104. Additionally, as shown in FIG. 2, each of the serving gNB 202, the neighbor gNB 204, and the LMF 206 may be configured to communicate (transmit and receive) with each other, such as signals or messages, and may be configured to communicate (transmit and receive) with one or more user device 102, either directly or indirectly via another component of the wireless access node 104. As a non-limiting example, the neighbor gNB 204 may communicate a message indirectly with a user device 102 by directly communicating the message to the serving gNB 202, and the serving gNB directly communicates the message to the user device 102. Also, although the example configuration in FIG. 2 shows a single neighbor gNB, other example configurations may include multiple neighbor gNBs. Also, herein, a gNB (including the serving gNB 202 and/or the neighbor gNB) can also or otherwise be called a transmission/reception point (TRP) or a next generation radio access network (NG-RAN). Further functionality of the serving gNB 202, the neighbor gNB 204, and the LMF 206 is described in further detail below.

In addition, referring back to FIG. 1, in various embodiments, two communication nodes in the wireless system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to a another wireless access node 104. Also, for sidelink transmissions, a first/source user device 102 directly transmits a sidelink signal to a second/destination user device 102 without any forwarding of the sidelink signal to a wireless access node 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels) are used to transmit data signals, and physical control channels (or just control channels) are used to transmit control signals. Example types of physical data channels include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a wireless access node 104 to a user device 102. In other embodiments, the control information includes uplink control information (UCI) that is transmitted in the uplink direction from a user device 102 to a wireless access node 104, or sidelink control information (SCI) that is transmitted in the sidelink direction from one user device 102(1) to another user device 102(2).

Additionally, for at least some embodiments, the user device 102 is configured as, or is capable of operating as, a low power high accuracy (LPHAP) user device 102. As a LPHAP user device, the user device 102 is configured to perform high accuracy positioning while saving power. For such embodiments described herein, the LPHAP user device 102 is configured to perform high accuracy positioning in an idle state (e.g., a RRC_INACTIVE state in accordance with 5G or other wireless communication standards) or an inactive state (e.g., a RRC_IDLE state in accordance with 5G or other wireless communication standards). The LPHAP user device 102 herein may be configured to receive a positioning reference signal (PRS) and/or send a sounding reference signal (SRS) for positioning when operating in the idle state or the inactive state. Such operation of the LPHAP user device 102 may be in contrast to other LPHAP user devices that have to wake up from the idle state or the inactive state in order to receive a positioning reference signal (PRS) and/or to send a SRS for positioning. By not having to wake up so frequently, the LPHAP user device 102 may not have to consume extra ramp up or ramp down power for waking up.

FIG. 3 shows an example method 300 for wireless communication that relates to positioning in the idle or inactive state. At block 302, the wireless access node 104 may determine a positioning time window to occur during an idle state or an inactive state of the user device 102. At block 304, the wireless access node 104 may transmit a positioning time window configuration to indicate the positioning time window for the idle state or the inactive state to the user device 102. The positioning time window configuration allows the user device 102 to receive a PRS or to transmit a SRS in the idle state or the inactive state.

FIG. 4 shows another example method 400 for wireless communication that relates to positioning in the idle or inactive state. At block 402, the user device 102 may receive a positioning time window configuration to indicate a positioning time window for an idle state or an inactive state from the wireless access node 104. At block 404, in response to receiving the positioning time window configuration, the user device 102 may at least one of: receive a PRS or transmit a SRS in the positioning time window in the idle state or the inactive state.

In further detail, for at least some embodiments of the method 300 and/or the method 400, the user device 102 may be configured with a paging cycle (or called a discontinuous reception (DRX) cycle) in the inactive state (e.g., RRC_INACTIVE) or in the idle state (e.g., RRC_IDLE). For at least some of these embodiments, a default paging cycle configuration may be broadcasted by the serving gNB 202. The default paging cycle contains at least a periodicity, an offset, and the location of a paging occasion (PO) in one paging cycle. In addition or alternatively, the user device 102 may receive and measure a synchronization signal block (SSB) from the serving gNB 202 and/or the neighbor gNB 204 in the inactive or idle state. A SSB can be configured to be measured in a time period called SSB-based measurement time configuration (SMTC).

Additionally, for at least some embodiments, when a positioning service triggers in the wireless communication system 100, the user device 102 may be scheduled to receive a PRS in the idle state or in the inactive state. In some embodiments, each time the user device receives a PRS, a SSB, a DCI, or a PDSCH, the user device 102 wakes up from a sleep mode (e.g., deep sleep, light sleep, or ultra sleep) to an active mode.

Additionally, when the user device 102 performs positioning, the serving gNB 202 and the neighbor gNB 204 send a PRS, and the LMF 206 sends a PRS configuration of all the gNBs. In various embodiments, some user device capability is reported to the serving gNB 202 via RRC signaling, and some user device capability is reported to the LMF 206 via LTE positioning protocol (LPP) signaling. Also, the user device 102 may report its measurement result of PRS related measurements to the LMF 206.

Additionally, for at least some embodiments of the method 300 and/or the method 400, the serving gNB 202 and/or the neighbor gNB(s) 204 may send a PRS to the user device 102 when the user device is in inactive state or the idle state. For at least some of these embodiments, when a positioning service triggers, the serving gNB 202 may also acquire the neighbor gNBs' 204 PRS configurations, such as from the LMF 206 via NRPPa MEASUREMENT PRECONFIGURATION REQUIRED message according to New Radio Positioning Protocol A (NRPPa). Then, the wireless access node (such as with the serving gNB 202) may configure one or more positioning time windows (also called a PRS reception window or a PRS processing window) in the inactive state or the idle state. In turn, the user device, the user device 102 may be allowed or configured to receive and/or process one or more PRS in the positioning time window(s), which in turn may reduce power consumption.

Additionally, for at least some embodiments of the method 300 and/or the method 400, the user device 102 may reports a capability to indicate it is a LPHAP user device and/or its capability to operate as a LPHAP to the wireless access node 102. For at least some of these embodiments, the user device 102 may report its capability directly to the serving gNB 202. Also, for at least some embodiments, the capability includes an indication whether the user device is a LPHAP user device. The indication may include a 1 bit indication, for example.

In addition or alternatively, the reported capability may include a power class or a power unit of the user device 102. For example, there may be several power classes to describe the user device's 102 power consumption. The user device 102 may report the one or more power classes it supports. Also, the wireless access node 104 may know that if the highest UE supported power class is lower than a threshold, the wireless access node 104 may determine or assume that the user device is a LPHAP user device.

In addition or alternatively, the reported capability may include mobility information. As examples, if the user device 102 is a stable LPHAP user device, the user device 102 may report its mobility information as ‘low’; if user device 102 is a wearable device kind of LPHAP user device, the user device 102 may report its mobility information as ‘high’. The mobility information can help the wireless access node 104 to determine a positioning time window configuration for the user device 102.

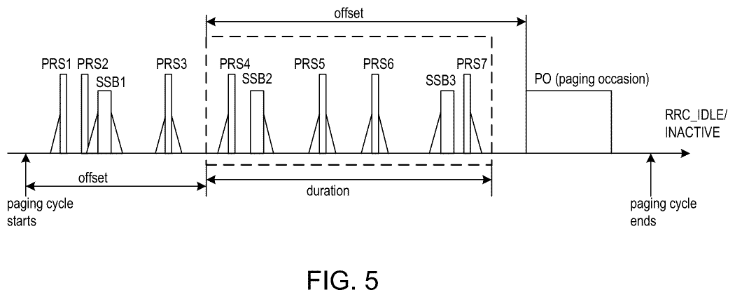

In addition, in various embodiments of the method 300 and/or the method 400, the positioning time window is a time window in the time domain. The wireless access node 104, such as with the serving gNB 202, may configure at least one of the following parameters of the positioning time window and/or include at least one of the following parameters for the positioning time window configuration: (1) a start time of the positioning time window (the start time can be an absolute time including a starting System Frame Number, a starting Subframe, a starting Slot and/or a corresponding subcarrier spacing (SCS)); (2) a periodicity of the positioning time window (The unit of the periodicity can be at least one of: symbol-level, sub-slot level, slot-level, sub-frame level, frame level); (3) a length (duration) of the positioning time window (The unit of the length can be at least one of symbol-level, sub-slot level, slot-level, sub-frame level, frame level.); (4) an offset between the start time of the positioning time window and a start time of a paging cycle (The unit of the offset can be at least one of symbol-level, sub-slot level, slot-level, sub-frame level, or frame level); (5) and offset between the start time of the positioning time window and a start time of a paging occasion (PO) in a paging cycle (The unit of the offset can be at least one of symbol-level, sub-slot level, slot-level, sub-frame level, frame level); (6) an offset between the start time of the positioning time window and an end time of the paging occasion (PO) in a paging cycle (The unit of the offset can be at least one of symbol-level, sub-slot level, slot-level, sub-frame level, frame level; (7) an offset between the start time of the positioning time window and a start time of a paging frame (PF) in a paging cycle (The unit of the offset can be at least one of symbol-level, sub-slot level, slot-level, sub-frame level, or frame level); or (8) an offset between the start time of the positioning time window and an end time of a paging frame (PF) in a paging cycle (The unit of the offset can be at least one of symbol-level, sub-slot level, slot-level, sub-frame level, frame level). FIG. 5 shows a timing diagram of an example of a positioning time window in accordance with one or more of the parameters included in a positioning time window.

In addition or alternatively, the wireless access node 104 may configure the positioning time window in accordance with at least one of: if the user device 102 does not indicate its capability to measure reduced PRS samples (e.g., 1 or 2), the positioning time window may include at least 4 PRS samples; if the user device 102 does not indicate its capability of reduced Rx beam sweeping factor (e.g., 1, 2, 4 or 6), a positioning time window may be configured to satisfy at least M PRS samples, with each PRS sample of 8 Rx beam sweeping times. For at least some of these embodiments, M can be 1, 2 or 4 according to TS38.133.

In addition or alternatively, for at least some embodiments, a period of the positioning time window may have a relationship with the period of a DRX cycle in the inactive state or the idle state. In particular, the positioning time window and the DRX cycle may have a one-to one mapping, and a positioning time window may not be configured to cross two DRX cycles. Alternatively, a periodicity of the positioning time window may be configured to be an integer multiple of the periodicity of the DRX cycle.

In other embodiments, the positioning time window may be configured to have a relationship with a SMTC in the idle state or the inactive state. The positioning time window configuration may indicate the relationship. For at least some of these embodiments, the user device 102 is provided the SMTC window, which may be contained in system information block 2 (SIB2), SIB4 and/or MeasIdleConfigDedicated-r16 for the inactive state or the idle state. Also, the wireless access node 104 may configure the same SMTC window for the same frequencies in common signaling (SIBx) and dedicated signaling (RRC Release). For such embodiments, the user device 102 may report in advance its capability to support performing radio resource management (RRM) measurement and PRS measurement in parallel. In addition or alternatively, a relationship between the positioning time window and SMTC may be established or configured in one of two ways.

In a first way, when the wireless access node 104 (e.g., the serving gNB 202) configures the SMTC window for the user device 102 to perform cell-reselection, the serving gNB 202 may also indicate the positioning time window to be reused with the SMTC in idle state and/or the inactive state. Here, reuse means that the positioning time window (and/or its corresponding positioning time window configuration) and the SMTC have at least one of: the same periodicity, the same offset, or the same duration. In addition or alternatively, reuse means that the user device 102 may receive and/or measures SSB and PRS in the same time period. For at least some of these embodiments, if the wireless access node 104 configures the positioning time window in accordance with the above, the wireless access node 104 may set the frequencies related to the SMTC window to be close to or be the same as the frequency layer(s) that the user device 102 is going to measure. In addition or alternatively, the serving gNB 202 may indicate the periodicity of the positioning time window to be an integer multiple of the SMTC window, or the periodicity of SMTC window to be an integer multiple of the positioning time window. An integer multiple of 1 may indicate that the positioning time window and the SMTC window fully overlap in each period. For such configurations, the start time and the duration of the positioning time window and the SMTC window should be the same. In other embodiments, the wireless access node 104 may configures an indication to indicate that the PRS can be measured in the existing SMTC window.

In a second way, the serving gNB 202 may indicate the positioning time window to be near the SMTC window. For example, the serving gNB 202 can configure an offset between the start time of the positioning time window and the start time of the SMTC window. For such embodiments, the duration and the periodicity of the positioning time window and SMTC window may be the same.

In addition or alternatively, if the PRS and the SSB overlap, such as by one or more symbols in the positioning time window, the wireless access node 104 (e.g, the serving gNB 202) may indicate to the user device 102 to prioritize PRS or SSB measurement or drop both over the overlapped symbols. In addition or alternatively, the user device 102 may indicate its capability in advance that the user device 102 will prioritize PRS or SSB or drop both when such overlapping occurs. In addition or alternatively, when the user device 102 moves from a serving cell to a neighbor cell in the inactive state and/or in the idle state, if the user device 102 is in one SMTC window to measure SSB/PRS, the user device 102 may continue to perform the PRS measurement until the end of the current SMTC window. After the SMTC window ends, the user device 102 may adopt the new SMTC window in the new cell broadcasting message (SIB2/SIB4) to be the new positioning time window. In other embodiments, if the user device 102 is in one SMTC window to measure SSB/PRS, the user device 102 may drop the PRS measurement in the SMTC window (and/or the positioning time window), and adopt the new SMTC window in the new cell broadcasting message (SIB2/SIB4) to be the new positioning time window.

In addition or alternatively, the positioning time window in the idle state or the inactive state may be configured via a radio resource control (RRC) message dedicated to a specific user device (for example in RRC Release or RRC Release-Suspend Config). In addition or alternatively; the positioning time window in the inactive state or the idle state can also be broadcasted in a new positioning SIB. For such embodiments, the LMF 206 may configure the positioning time window and forward the time window configuration to serving gNB via NRPPa ASSISTANCE INFORMATION CONTROL message.

Also, for embodiments where the positioning time window has a relationship with the SMTC, RRC signaling may indicate to the user device 102 whether the SMTC window (or which SMTC window) can be used to measure PRS. Alternatively, the LMF 206 may activate or deactivate the positioning time window via a POSITIONING ACTIVATION REQUEST and POSITIONING DEACTIVATION, or via new IE(s) in 38.455.

In addition or alternatively, for at least some embodiments, when the serving gNB 202 configures the positioning time window for the inactive state and/or the idle state, the serving gNB 202 may need to know the capability of the user device to operate as a LPHAP user device and the PRS processing capability in inactive state or the idle state of the user device 102, in order to configure a suitable time location and duration of the positioning time window. For example, at least one of the following UE capability may be transmitted from the user device 102 to the serving gNB 202: (1) downlink (DL) PRS buffering capability in the inactive state (e.g., in the RAN1 feature list 27-6), including at least one of: (a) Type 1-sub-slot/symbol level buffering, or (b) Type 2-slot level buffering; (2) a duration of DL PRS symbols N (e.g., in units of milliseconds (ms)) that the user device 102 can process every T ms assuming maximum DL PRS bandwidth in MHz in RRC_INACTIVE (e.g., in the RAN1 feature list 27-6); (3) support of the lower Rx beam sweeping factor than 8 for FR2 (e.g., in the RAN1 feature list 27-9); (4) a number of Rx beam sweeping factors (e.g., in the RAN1 feature list 27-9); or (5) a capability of supporting a reduced number of samples (e.g., M=1, 2) for PRS measurement in the RRC_inactive state (e.g., in the RAN1 feature list 14-2).

In other embodiments, after the LMF 206 receives the user device's 102 capability, the LMF 206 may indicate the capability to the serving gNB 202. For example, the LMF 206 may indicate the above capability to the serving gNB 202 via MEASUREMENT PRECONFIGURATION REQUIRED, PRS CONFIGURATION REQUEST, POSITIONING INFORMATION REQUEST or TRP INFORMATION REQUEST.

In addition or alternatively, the LMF 206 may send the SMTC of each gNB (including the serving gNB 202 and/or the neighbor gNB 204) to the user device 102 in assistance data, for example in NR-SSB-config.

In addition or alternatively, the user device 102 may report its capabilities, including those indicating it is a LPHAP user device or related attributes as previously described, directly to the LMF 206. In addition or alternatively, the user device 102 may indicate its capabilities to the serving gNB 202, and then the serving gNB 202 may send capabilities to the LMF 206. In this way, the serving gNB 202 can directly forward the capability to the LMF 206, or the serving gNB 202 may send the recommended power consumption for the positioning service to the LMF 206.

In addition, for at least some embodiments, when the LMF 206 determines that the user device 102 is a LPHAP user device, the LMF 206 may determine that the LPHAP user device 102 is always in the inactive state and/or in the idle state. Correspondingly, the LMF 206 may send a request message to the serving gNB 202 and/or the neighbor gNB(s) 204 to request them to configure suitable positioning time windows for each gNB. The LMF 206 can also send the requested positioning time window characteristics to the serving gNB 202 and/or the neighbor gNB(s) 204. This may be done, for example, via MEASUREMENT PRECONFIGURATION REQUIRED, PRS CONFIGURATION REQUEST, POSITIONING INFORMATION REQUEST or TRP INFORMATION REQUEST. In turn, the serving gNB 202 and/or the neighboring gNB(s) may respond to the LMF 206 with their corresponding positioning time window configuration. For at least some of these embodiments, the responses with the corresponding positioning time window may be provided, for example, via MEASUREMENT PRECONFIGURATION CONFIRM, PRS CONFIGURATION RESPONSE, TRP INFORMATION RESPONSE, or POSITIONING INFORMATION RESPONSE. The requested characteristics or the configuration of the positioning time window include one or more of the parameters of the positioning time window as previously described.

In other embodiments, the LMF 206 may send a request message to the serving gNB 202 and/or the neighbor gNB(s) to them request to report their corresponding SMTC configurations. In addition or alternatively, the serving gNB 202 and/or the neighbor gNB(s) may send the SMTC window configuration to the LMF 206, which in turn may help the LMF 202 configure the positioning time window to have a relationship with the SMTC window. For at least some of these embodiments, the SMTC window configuration transferred to the LMF 206 may include or indicate the periodicity, the offset and the duration of the timing occasion at which the user device 102 measures SSBs. In particular of these embodiments, this information can be included in MEASUREMENT PRECONFIGURATION CONFIRM, PRS CONFIGURATION RESPONSE, TRP INFORMATION RESPONSE, or POSITIONING INFORMATION RESPONSE.

In addition or alternatively, the LMF 206 may configure or determine the time window for LPHAP UE in the assistance data. For example, the LMF 206 may determine the positioning time window configuration to be under an assistance data configuration of each of one or more TRPs. Correspondingly, when the user device 102 receives the positioning time window configuration and the PRS resources of one or more TRPs, the user device 102 may receive and/or process PRS from the corresponding TRP in the corresponding positioning time window. For at least some embodiments, the positioning time windows of multiple TRPs may be overlapped or non-overlapped in the time domain. In other embodiments, the LMF 206 may configure or determine the positioning time window configuration to be under an assistance data configuration of each PRS frequency layer.

In addition or alternatively, the LMF 206 may determine the positioning time window configuration, and may send the positioning time window configuration to the serving gNB 202. In turn, the serving gNB 202 may transmit the positioning time window configuration to the user device 102 via broadcasting. For at least some of these embodiments, the serving gNB may broadcast via Positioning SIB Type, Assistance Information and/or ASSISTANCE INFORMATION CONTROL. The broadcasting PRS window may contain in a new positioning SIB, or in NR-DL-PRS-AssistanceData in legacy positioning SIB.

In addition or alternatively, the user device 102 may report its capability on whether it supports one or more positioning time windows in the inactive state and/or the idle state. For at least some of these embodiments, the user device 102 reports this capability to the LMF 206 and/or the serving gNB 202.

In addition or alternatively, for at least some embodiments, the user device 102 may monitor a permanent equipment identifier (PEI) before each paging cycle to decide whether to monitor the PO in the next paging cycle. If the user device 102 is configured with a positioning time window, such as via dedicated signaling, an indication can also be provided to user device 102 on whether to wake up and receive/process PRS in the positioning time window in the next one or more paging cycles. For at least some of these embodiments, the indication may be embedded in a DCI format 2-7. In particular of these embodiments, the indication may include 1 bit to indicate whether to measure PRS in the next PRS time window or in the next several N PRS time windows, where N is an integer and can be indicated in the RRC signaling, or can be UE caqpability reporting.

In addition or alternatively, in inactive state and/or the idle state, when configured with multi-cell round trip time (multi-RTT) schedules, the user device 102 may receive the PRS and send the SRS for positioning. In addition or alternatively, when configured with uplink time difference of arrival (UL-TDOA) and/or uplink angle-of-arrival (UL-AoA) schedules, the user device 102 may send SRS for positioning. In addition or alternatively, when the serving gNB 202 configures the user device 102 with periodic SRS for positioning, the serving gNB 202 may also configure a SRS time window to indicate to the user device 102 when to start and stop sending SRS for positioning. If multi-RTT is scheduled, the time location of the SRS time window can be the same as the positioning time window. For at least some of these embodiments, the SRS time window can be included in the positioning time window configuration, such as in RRC_Release with Suspend Config, or in RRC_Release. In addition or alternatively, the LMF 206 may request the serving gNB 202 to configure the SRS time window in Requested SRS Transmission Characteristics IE in 38.455. In addition or alternatively, the LMF 206 may activate or deactivate the SRS time window, such as via POSITIONING ACTIVATION REQUEST and POSITIONING DEACTIVATION.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication that includes: determining, with a wireless access node, a positioning time window to occur during an idle state or an inactive state of a user device; and transmitting, with the wireless access node, a positioning time window configuration to indicate the positioning time window for the idle state or the inactive state to the user device, wherein the user device is allowed to receive a positioning reference signal (PRS) or to transmit a sounding reference signal (SRS) in the idle state or the inactive state.

A second aspect includes the first aspect, and further includes: receiving, with the wireless access node, a capability of the user device to operate as a low power high accuracy positioning (LPHAP) user device from the user device.

A third aspect includes the second aspect, and further includes wherein receiving the capability includes receiving, with a serving gNB of the wireless access node, the capability from the user device.

A fourth aspect includes any of the second or third aspects, and further includes wherein receiving the capability comprises: receiving, with a location management function (LMF) of the wireless access node, the capability from the user device.

A fifth aspect includes the fourth aspect, and further includes: indicating, with the LMF, the capability to a serving gNB or a neighbor gNB of the wireless access node.

A sixth aspect includes any of the second through fifth aspects, and further includes wherein the capability comprises a power class of the user device.

A seventh aspect includes any of the second through sixth aspects, and further includes wherein the capability comprises mobility information of the user device.

An eighth aspect includes any of the second through seventh aspects, and further includes wherein the capability comprises a PRS processing capability in the inactive state or the idle state.

A ninth aspect includes any of the first through eighth aspects, and further includes wherein the positioning time window configuration comprises at least one of: a start time of the positioning time window, a periodicity of the positioning time window, a length of the positioning time window, an offset between the start time and a start time of a paging cycle, an offset between the start time of the positioning time window and a start time of a paging occasion (PO) in the paging cycle; or an offset between the start time of the positioning time window and a start time of a paging frame (PF) in the paging cycle.

A tenth aspect includes any of the first through ninth aspects, and further includes wherein the positioning time window configuration indicates a relationship between the positioning time window and a synchronization signal block (SSB)-based Measurement Time Configuration (SMTC) for the idle state or the inactive state.

An eleventh aspect includes the tenth aspect, and further includes wherein the relationship comprises that the positioning time window configuration and the SMTC have at least one of: the same periodicity, the same offset, or the same duration.

A twelfth aspect includes the tenth aspect, and further includes wherein the relationship comprises an offset between a start time of the positioning time window and a start time of the SMTC.

A thirteenth aspect includes the tenth aspect, and further includes wherein the relationship comprises an indication to indicate the PRS is received within a time period indicated by the SMTC.

A fourteenth aspect includes any of the first through thirteenth aspects, and further includes: sending, with the LMF, a request message to at least one of a serving gNB or at least one neighbor gNB to configure at least one respective positioning time window configuration for the serving gNB or the at least one neighbor gNB.

A fifteenth aspect includes the fourteenth aspect, and further includes: in response to receiving the request message, sending, with at least one of the serving gNB or the at least one neighbor gNB, the at least one respective positioning time window configuration to the LMF.

A sixteenth aspect includes any of the fourteenth or fifteenth aspects, and further includes: determining, with the LMF, the positioning time window configuration to be under an assistance data configuration of each transmission/reception point (TRP).

A seventeenth aspect includes any of the fourteenth or fifteenth aspects, and further includes: determining, with the LMF, the positioning time window configuration to be under an assistance data configuration of each PRS frequency layer.

An eighteenth aspect includes any of the first through seventeenth aspects, and further includes: determining, with a location management function (LMF) of the wireless access node, the positioning time window configuration; sending, with the LMF, the positioning time window configuration to a serving gNB of the user device; and transmitting, with the serving gNB, the positioning time window configuration via broadcasting to the user device.

A nineteenth aspect includes any of the first through eighteenth aspects, and further includes: receiving, with the wireless access node, a capability of the user device to support one or more positioning time windows in the inactive state or the idle state.

A twentieth aspect includes any of the first through nineteenth aspects, and further includes: transmitting, with the wireless access node, an indication for the user device whether to receive at least one of the PRS in a next one or more paging cycles, wherein the indication is embedded in a downlink control information (DCI) format 2-7.

A twenty-first aspect includes a method for wireless communication that includes: receiving, with a user device, a positioning time window configuration to indicate a positioning time window for an idle state or an inactive state from a wireless access node; and in response to receiving the positioning time window configuration, with the user device, at least one of: receiving a positioning reference signal (PRS) or transmitting a sounding reference signal (SRS) in the positioning time window in the idle state or the inactive state.

A twenty-second aspect includes the twenty-first aspect, and further includes: transmitting, with the user device, a capability of the user device to operate as a low power high accuracy positioning (LPHAP) user device to the wireless access node.

A twenty-third aspect includes the twenty-second aspect, and further includes: transmitting, with the user device, the capability to a serving gNB of the wireless access node.

A twenty-fourth aspect includes any of the twenty-first through twenty-third aspects, and further includes: wherein transmitting the capability comprises: transmitting, with the user device, the capability to a location management function (LMF) of the wireless access node.

A twenty-fifth aspect includes any of the twenty-second through twenty-fourth aspects, and further includes wherein the capability comprises a power class of the user device.

A twenty-sixth aspect includes any of the twenty-second through twenty-fifth aspects, and further includes wherein the capability comprises mobility information of the user device.

A twenty-seventh aspect includes any of the twenty-second through twenty-sixth aspects, and further includes wherein the capability comprises a PRS processing capability in the inactive state or the idle state.

A twenty-eighth aspect includes any of the twenty-first through twenty-seventh aspects, and further includes wherein the positioning time window configuration comprises at least one of: a start time of the positioning time window, a periodicity of the positioning time window, a length of the positioning time window, an offset between the start time and a start time of a paging cycle, an offset between the start time of the positioning time window and a start time of a paging occasion (PO) in the paging cycle; or an offset between the start time of the positioning time window and a start time of a paging frame (PF) in the paging cycle.

A twenty-ninth aspect includes any of the twenty-first through the twenty-eighth aspects, and further includes wherein the positioning time window configuration indicates a relationship between the positioning time window and a synchronization signal block (SSB)-based Measurement Time Configuration (SMTC) for the idle state or the inactive state.

A thirtieth aspect includes the twenty-ninth aspect and further includes wherein the relationship comprises that the positioning time window configuration and the SMTC have at least one of: the same periodicity, the same offset, or the same duration.

A thirty-first aspect includes the twenty-ninth aspect, and further includes wherein the relationship comprises an offset between a start time of the positioning time window and a start time of the SMTC.

A thirty-second aspect includes any of the twenty-ninth through thirty-first aspects, and further includes wherein the relationship comprises an indication to indicate the PRS is received within a time period indicated by the SMTC.

A thirty-third aspect includes any of the twenty-first through thirty-second aspects, and further includes wherein the positioning time window configuration is configured to be under each assistance data configuration of each transmission/reception point (TRP).

A thirty-fourth aspect includes any of the twenty-first through thirty-second aspects, and further includes wherein the positioning time window configuration is configured to be under an assistance data configuration of each PRS frequency layer.

A thirty-fifth aspect includes any of the twenty-first through thirty-fourth aspects, and further includes: transmitting, with the user device, a capability of the user device to support one or more positioning time windows in the inactive state or the idle state.

A thirty-sixth aspect includes any of the twenty-first through thirty-fifth aspects, and further includes: receiving, with the user device, an indication for the user device whether to receive at least one of the PRS in a next one or more paging cycles, wherein the indication is embedded in a downlink control information (DCI) format 2-7.

A thirty-seventh aspect includes a wireless communications apparatus comprising a processor and a memory, wherein the processor is configured to read code from the memory to implement any of the first through thirty-sixth aspects.

A thirty-eighth aspect includes a computer program product comprising a computer-readable program medium comprising code stored thereupon, the code, when executed by a processor, causing the processor to implement any of the first through thirty-sixth aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
determining, with a wireless access node, a positioning time window to occur during an idle state or an inactive state of a user device; and
transmitting, with the wireless access node, a positioning time window configuration to indicate the positioning time window for the idle state or the inactive state to the user device, wherein the user device is allowed to receive a positioning reference signal (PRS) or to transmit a sounding reference signal (SRS) in the idle state or the inactive state.

2. The method of claim 1, further comprising:
receiving, with the wireless access node, a capability of the user device to operate as a low power high accuracy positioning (LPHAP) user device from the user device.

3. The method of claim 2, wherein receiving the capability comprises:
receiving, with a serving gNB of the wireless access node, the capability from the user device.

4. The method of claim 2, wherein receiving the capability comprises:
receiving, with a location management function (LMF) of the wireless access node, the capability from the user device; and
indicating, with the LMF, the capability to a serving gNB or a neighbor gNB of the wireless access node.

5. The method of claim 2, wherein the capability comprises: a power class of the user device, mobility information of the user device, or a PRS processing capability in the inactive state or the idle state.

6. The method of claim 1, wherein at least one of:
the positioning time window configuration comprises at least one of: a start time of the positioning time window, a periodicity of the positioning time window, a length of the positioning time window, an offset between the start time and a start time of a paging cycle, an offset between the start time of the positioning time window and a start time of a paging occasion (PO) in the paging cycle; or an offset between the start time of the positioning time window and a start time of a paging frame (PF) in the paging cycle; or
the positioning time window configuration indicates a relationship between the positioning time window and a synchronization signal block (SSB)-based Measurement Time Configuration (SMTC) for the idle state or the inactive state.

7. The method of claim 6, wherein the relationship comprises one of:
that the positioning time window configuration and the SMTC have at least one of: the same periodicity, the same offset, or the same duration;
an offset between a start time of the positioning time window and a start time of the SMTC; or
an indication to indicate the PRS is received within a time period indicated by the SMTC.

8. The method of claim 1, further comprising:
sending, with the LMF, a request message to at least one of a serving gNB or at least one neighbor gNB to configure at least one respective positioning time window configuration for the serving gNB or the at least one neighbor gNB.

9. The method of claim 8, further comprising:
in response to receiving the request message, sending, with at least one of the serving gNB or the at least one neighbor gNB, the at least one respective positioning time window configuration to the LMF.

10. The method of claim 8, further comprising:
determining, with the LMF, the positioning time window configuration to be under an assistance data configuration of each transmission/reception point (TRP) or of each PRS frequency layer.

11. The method of claim 1, further comprising:
determining, with a location management function (LMF) of the wireless access node, the positioning time window configuration;
sending, with the LMF, the positioning time window configuration to a serving gNB of the user device; and
transmitting, with the serving gNB, the positioning time window configuration via broadcasting to the user device.

12. The method of claim 1, further comprising:
transmitting, with the wireless access node, an indication for the user device whether to receive at least one of the PRS in a next one or more paging cycles, wherein the indication is embedded in a downlink control information (DCI) format 2-7.

13. A method for wireless communication, the method comprising:
receiving, with a user device, a positioning time window configuration to indicate a positioning time window for an idle state or an inactive state from a wireless access node;
in response to receiving the positioning time window configuration, with the user device, at least one of: receiving a positioning reference signal (PRS) or transmitting a sounding reference signal (SRS) in the positioning time window in the idle state or the inactive state.

14. The method of claim 13, further comprising:
transmitting, with the user device, a capability of the user device to operate as a low power high accuracy positioning (LPHAP) user device to a serving gNB or a location management function (LMF) of the wireless access node.

15. The method of claim 14, wherein the capability comprises a power class of the user device, mobility information of the user device, or a PRS processing capability in the inactive state or the idle state.

16. The method of claim 13, wherein the positioning time window configuration comprises at least one of: a start time of the positioning time window, a periodicity of the positioning time window, a length of the positioning time window, an offset between the start time and a start time of a paging cycle, an offset between the start time of the positioning time window and a start time of a paging occasion (PO) in the paging cycle; or an offset between the start time of the positioning time window and a start time of a paging frame (PF) in the paging cycle.

17. The method of claim 13, wherein the positioning time window configuration indicates a relationship between the positioning time window and a synchronization signal block (SSB)-based Measurement Time Configuration (SMTC) for the idle state or the inactive state,
wherein the relationship comprises one of: that the positioning time window configuration and the SMTC have at least one of: the same periodicity, the same offset, or the same duration; an offset between a start time of the positioning time window and a start time of the SMTC; or an indication to indicate the PRS is received within a time period indicated by the SMTC.

18. The method of claim 13, wherein the positioning time window configuration is configured to be under each assistance data configuration of each transmission/reception point (TRP) or of each PRS frequency layer.

19. The method of claim 13, further comprising:
transmitting, with the user device, a capability of the user device to support one or more positioning time windows in the inactive state or the idle state.

20. A wireless communications apparatus comprising:
a memory storing a plurality of instructions; and
at least one processor configured to execute the plurality of instructions, and upon execution of the plurality of instructions, is configured to cause the wireless communications apparatus to:
determine a positioning time window to occur during an idle state or an inactive state of a user device; and
transmit a positioning time window configuration to indicate the positioning time window for the idle state or the inactive state to the user device, wherein the user device is allowed to receive a positioning reference signal (PRS) or to transmit a sounding reference signal (SRS) in the idle state or the inactive state.
